(19) United States
(12) Patent Application Publication
(10) Pub. No.: US 2026/0341821 A1
(43) Pub. Date: Oct. 29, 2026

(54) BATTERY CELL, BATTERY DEVICE INCLUDING THE SAME AND BATTERY CELL MANUFACTURING METHOD

(71) Applicant: SK On Co., Ltd., Seoul (KR)

(72) Inventor: Chang Geun SON, Daejeon (KR)

(21) Appl. No.: 19/647,913

(22) Filed: Apr. 15, 2026

(30) Foreign Application Priority Data
Apr. 25, 2025 (KR) 10-2025-0054362

(51) Int. Cl. H01M 10/48; H01M 50/103; H01M 50/15; H01M 50/636

(52) U.S. Cl. CPC H01M 10/488; H01M 10/486; H01M 50/103; H01M 50/15; H01M 50/636

(57) ABSTRACT

A battery cell is disclosed. In some implementations, the battery cell includes: a cell case having an internal space and including an opening in at least one side thereof; an electrode assembly disposed in the internal space; a cap plate covering the opening of the cell case; a vent portion opened as the internal space reaches a pressure within a predetermined pressure range; an air hole formed in the cap plate and providing a passage through which internal air of the cell case is discharged during electrolyte injection; an injection hole formed in the cap plate and providing a passage through which electrolyte is injected; and a temperature determining unit at least partially discolored according to an internal temperature of the cell case, wherein the temperature determining unit is installed in the air hole.

### CROSS-REFERENCE TO RELATED APPLICATION(S)

This patent document claims the priority and benefits of Korean Patent Application No. 10-2025-0054362 filed on Apr. 25, 2025, the disclosure of which is incorporated herein by reference in its entirety.

### TECHNICAL FIELD

The disclosure and implementations disclosed in this patent document generally relate to a battery cell, a battery device including the same, and a battery cell manufacturing method.

### BACKGROUND

The secondary battery may be rechargeable and dischargeable, unlike the primary battery, and may thus be applied to devices within various fields such as a digital camera, a mobile phone, a laptop computer, a hybrid vehicle, and an electric vehicle. Examples of the secondary battery may include a nickel-cadmium battery, a nickel-metal hydride battery, a nickel-hydrogen battery, a lithium secondary battery, and the like.

A plurality of secondary batteries may be stacked to form a cell assembly, and may be disposed in a housing to form a part of a battery device such as a battery module or a battery pack.

### SUMMARY

A passage through which an interior and an exterior of the battery cell communicate with each other is only an injection hole, and air in the battery cell is thus difficult to discharge outwardly during electrolyte injection. Accordingly, a large amount of time may be required for electrolyte injection.

In addition, a method for determining an internal temperature of the battery cell has been limited, and determining an internal state of the battery cell from a production process to after completion is thus difficult.

The present disclosure may be implemented in some embodiments to provide a battery cell, a battery device including the same, and a battery cell manufacturing method in which an electrolyte injection speed is improved, thereby improving processability.

The present disclosure may be implemented in some embodiments to provide a battery cell, a battery device including the same, and a battery cell manufacturing method in which an internal state of the battery cell is capable of being intuitively determined.

The battery cell, the battery device including the same, and the battery cell manufacturing method according to the present disclosure may be widely applied to green technology fields such as an electric vehicle, a battery charging station, solar power generation using a battery, or wind power generation using a battery. In addition, the battery cell, the battery device including the same, and the battery cell manufacturing method according to the present disclosure may be used in an eco-friendly electric vehicle, a hybrid vehicle, or the like for suppressing air pollution and greenhouse gas emissions to ameliorate the effects of climate change.

In some embodiments of the present disclosure, a battery cell includes: a cell case having an internal space and including an opening in at least one side thereof; an electrode assembly disposed in the internal space; a cap plate covering the opening of the cell case; a vent portion opened as the internal space reaches a pressure within a predetermined pressure range; an air hole formed in the cap plate and providing a passage through which internal air of the cell case is discharged during electrolyte injection; an injection hole formed in the cap plate and providing a passage through which electrolyte is injected; and a temperature determining unit at least partially discolored according to an internal temperature of the cell case, wherein the temperature determining unit is installed in the air hole.

The temperature determining unit may include a body portion coupled to the air hole and including an accommodation space therein, a discoloration material accommodated in the accommodation space and discolored as temperature changes, and a cover covering an opening of the body portion.

At least a part of the cover may be formed of a transparent material to allow a color of the discoloration material to be determined from the outside.

The discoloration material may include at least one thermochromic pigment discolored at a specific temperature.

The discoloration material may include a first thermochromic pigment discolored to a first color at a first temperature, and a second thermochromic pigment discolored to a second color at a second temperature higher than the first temperature, and the first color and the second color may differ from each other.

At least a part of the temperature determining unit may be disposed in the cell case.

In some embodiments of the present disclosure, a battery device includes: a cell assembly including a plurality of battery cells; and a housing including a housing body in which the cell assembly is disposed and a housing cover covering the cell assembly, wherein the battery cell includes a cell case having an internal space and including an opening in at least one side thereof; an electrode assembly disposed in the internal space; a cap plate covering the opening of the cell case; a vent portion opened as the internal space reaches a pressure within a predetermined pressure range; an air hole formed in the cap plate and providing a passage through which internal air of the cell case is discharged during electrolyte injection; an injection hole formed in the cap plate and providing a passage through which electrolyte is injected; and a temperature determining unit discolored according to an internal temperature of the cell case, the temperature determining unit being installed in the air hole.

The temperature determining unit may include a body portion coupled to the air hole and including an accommodation space therein, a discoloration material accommodated in the accommodation space and discolored as temperature changes, and a cover covering an opening of the body portion.

At least a part of the cover may be formed of a transparent material to allow a color of the discoloration material to be determined from the outside.

At least a part of the temperature determining unit may face the housing cover.

The cover may face the housing cover.

In some embodiments of the present disclosure, a battery cell manufacturing method includes: injecting electrolyte into a battery cell through an injection hole; sealing the injection hole; and installing, in the battery cell, a temperature determining unit capable of determining an internal temperature of the battery cell, wherein the temperature determining unit is installed in an air hole providing a passage through which internal air of the battery cell is discharged during electrolyte injection into the battery cell.

The injecting may include discharging air in an internal space outward from a cell case through the air hole during electrolyte injection.

The installing may be performed after the injecting.

### BRIEF DESCRIPTION OF DRAWINGS

Certain aspects, features, and advantages of the present disclosure are illustrated by the following detailed description with reference to the accompanying drawings.

FIG. 1 is a perspective view of a battery cell according to an embodiment.

FIG. 2 is a cross-sectional view taken along line I-I’ of FIG. 1.

FIG. 3 is an enlarged perspective view of portion A of FIG. 1.

FIG. 4 is a perspective view of a battery device according to an embodiment.

FIG. 5 is a flowchart of a battery cell manufacturing method according to an embodiment.

FIGS. 6A-6C are a cross-sectional view of the battery cell during an electrolyte injection process.

### DETAILED DESCRIPTION

Features of the present disclosure disclosed in this patent document are described by example embodiments with reference to the accompanying drawings.

The present disclosure may be implemented in some embodiments to provide a battery cell, a battery device including the same, and a battery cell manufacturing method.

The same reference numerals or symbols used in the drawings attached to the present specification denote parts or components performing substantially the same functions. For convenience of description and understanding, identical reference numerals or symbols may be used in different embodiments. That is, even though components having identical reference numerals are illustrated in a plurality of drawings, the plurality of drawings do not necessarily all represent one embodiment.

In the following description, a term of a singular number may include its plural number unless the context clearly indicates otherwise. Terms such as “include” or “configure” are intended to specify the presence of features, numbers, steps, operations, components, parts, or combinations thereof described in the specification, and are not intended to preclude the presence or addition of one or more other features, numbers, steps, operations, components, parts, or combinations thereof.

In addition, in the following description, expressions such as upper side, upper portion, lower side, lower portion, side, front, and rear are expressed based on directions illustrated in the drawings, and it is noted in advance that these expressions may be expressed differently when a direction of the corresponding object changes.

In addition, in the present specification and claims, terms including ordinal numbers such as “first” and “second” may be used to distinguish components from each other. These ordinal numbers are used to distinguish identical or similar components from each other, and the meanings of the terms should not be construed as being limited by the use of these ordinal numbers. For example, components combined with these ordinal numbers should not be construed as limiting an order of use or order of arrangement by the numbers. If necessary, the ordinal numbers may be used interchangeably with each other.

Hereinafter, the present disclosure is described in detail with reference to the accompanying drawings. However, the present disclosure is merely illustrative, and is not limited to the specific embodiments illustratively described.

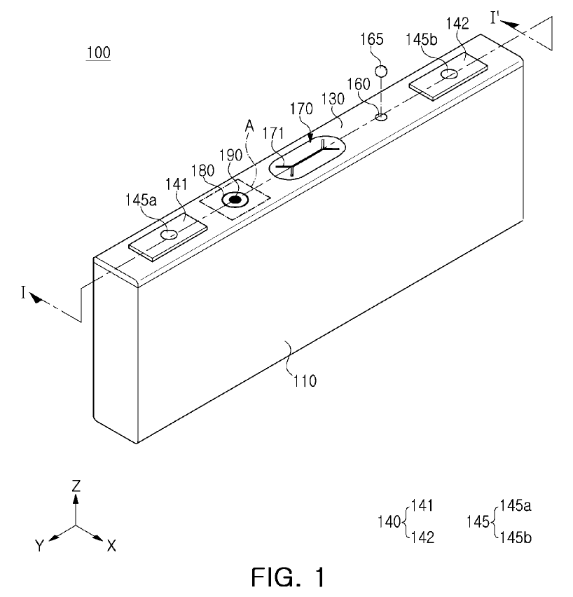

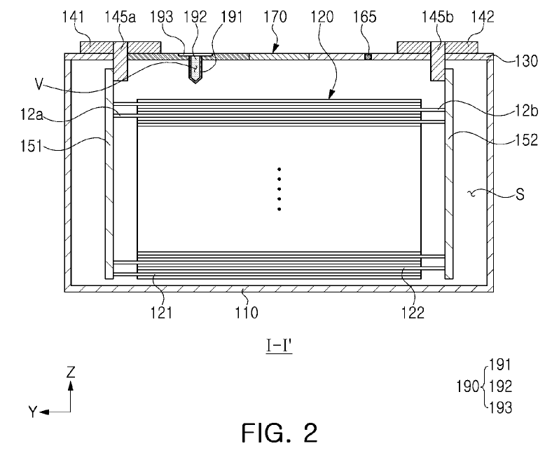

FIG. 1 is a perspective view of a battery cell 100 according to an embodiment. FIG. 2 is a cross-sectional view taken along line I-I′ of FIG. 1.

Referring to FIGS. 1 and 2, the battery cell 100 may include a cell case 110 having an internal space S and including an opening in at least one side thereof, an electrode assembly 120 disposed in the internal space S, a cap plate 130 covering the opening of the cell case 110, a vent portion 170 opened as the internal space S reaches a pressure within a predetermined pressure range, an air hole 180 formed in the cap plate 130 and providing a passage through which internal air of the cell case 110 is discharged during electrolyte injection, an injection hole 160 formed in the cap plate 130 and providing a passage through which electrolyte is injected, and a temperature determining unit 190 discolored according to an internal temperature of the cell case 110.

The battery cell 100 may be a secondary battery. For example, the battery cell 100 may be a lithium secondary battery, a nickel-cadmium battery, a nickel-metal hydride battery, a nickel-hydrogen battery, or the like.

The battery cell 100 may be a can-type secondary battery in which the electrode assembly 120 is accommodated in the cell case 110 having rigidity. The can-type secondary battery may be classified into a cylindrical secondary battery and a prismatic secondary battery according to an external shape thereof. In the present disclosure, a prismatic secondary battery is described as the battery cell 100. However, the battery cell 100 does not exclude a cylindrical secondary battery.

The cell case 110 may have a rectangular parallelepiped shape. The cell case 110 may be formed of aluminum, and accordingly, the cell case 110 may be designed to have cathode polarity.

The cell case 110 may form the internal space S. The electrode assembly 120 and an electrolyte may be accommodated in the internal space S. The cell case 110 may include the opening in at least one side thereof. The electrode assembly 120 may be accommodated in the cell case 110 through the opening.

The electrode assembly 120 may include an anode 121, a cathode 122, and a separator 123. For example, the electrode assembly 120 may have the anode 121 and the cathode 122 alternately stacked with the separator 123 interposed therebetween, or may have a stacked structure that is wound.

The electrode assembly 120 may have a length in a length direction of the cell case 110 having the rectangular parallelepiped shape. For example, the anode 121, the cathode 122, and the separator 123 may have lengths in the length direction of the cell case 110 having the rectangular parallelepiped shape.

The anode 121 and the cathode 122 may be formed by coating electrode active materials on current collectors having a thin film or foil shape with a thickness of about 10 μm. For example, the anode 121 may be formed by coating an electrode active material such as graphite or carbon on a current collector such as copper, a copper alloy, nickel, or a nickel alloy. On the other hand, the cathode 122 may be formed by coating an electrode active material such as a transition metal oxide on a current collector such as aluminum or an aluminum alloy. However, materials of the current collectors and electrode active materials of the anode 121 and the cathode 122 are not limited to the above-exemplified materials.

Meanwhile, the anode 121 and the cathode 122 may include a uncoated region 12 in which the electrode active material is not coated on the current collector. The uncoated region 12 may be a portion drawn out in a length direction of each of the anode 121 and the cathode 122. The uncoated region 12 may be electrically connected to a current collecting plate 150 described below and may serve as a current flow path between the anode 121 and the cathode 122 and an external portion.

The separator 123 may be interposed between the anode 121 and the cathode 122 to prevent direct contact between the anode 121 and the cathode 122. Simultaneously, the separator 123 may include pores having a minute size on a surface thereof to allow movement of lithium ions included in the electrolyte. For example, the separator 123 may be formed of polyethylene (PE) or polypropylene (PP). However, a material of the separator 123 is not limited thereto.

Electrolyte may be accommodated together with the electrode assembly 120 in the internal space S formed by the cell case 110. For example, electrolyte may include a lithium salt such as lithium hexafluorophosphate (LiPF6) or lithium tetrafluoroborate (LiBF4) in an organic solvent such as ethylene carbonate (EC), propylene carbonate (PC), diethyl carbonate (DEC), ethyl methyl carbonate (EMC), or dimethyl carbonate (DMC). In addition, electrolyte may be in a liquid phase, a solid phase, or a gel phase.

The cell case 110 may include the opening in at least one side thereof. The cap plate 130 may be disposed at the opening, and the cap plate 130 may cover the opening to seal the internal space S.

The cell case 110 may include the opening at one side (one-way type). For example, the cell case 110 may include the opening at one side in a Z direction based on the drawings. In this embodiment, the opening may have a length in the length direction of the cell case 110, and the cap plate 130 may cover the opening. The cap plate 130 may be coupled to the cell case 110 while covering the opening. The cap plate 130 may be formed of aluminum and may be welded to the cell case 110 along a circumference of the opening.

The cell case 110 may include the openings at both sides in the length direction (X-direction), and the cap plates 130 may respectively cover the openings (two-way type). That is, although the present disclosure is described based on a case in which the opening is formed at one side of the cell case 110 (one-way type), the cell case 110 is not limited thereto, and a case in which the openings are formed at both sides of the cell case 110 may also be included in the present disclosure.

The cap plate 130 may include electrode terminals 140 (141 and 142). For example, the cap plate 130 may include the anode terminal 141 and the cathode terminal 142. The anode terminal 141 may be electrically connected to the anode 121 of the electrode assembly 120 to have anode polarity, and the cathode terminal 142 may be electrically connected to the cathode 122 of the electrode assembly 120 to have cathode polarity.

The anode terminal 141 and the cathode terminal 142 may each have a plate shape and may be disposed on one surface of the cap plate 130 to be spaced apart from each other in the length direction X. One surface of the cap plate 130 may refer to a surface opposite to a surface facing the internal space S. However, the anode terminal 141 and the cathode terminal 142 are not limited to the above-described embodiment as long as the anode terminal 141 and the cathode terminal 142 may be electrically connectable to an external portion.

The anode terminal 141 and the cathode terminal 142 may be electrically connected to current collecting plates 150 (151 and 152). The current collecting plates 150 may be connected to the uncoated regions 12 (12a and 12b) of the electrode assembly 120 and may have anode polarity or cathode polarity. The anode terminal 141 may be electrically connected to the anode current collecting plate 151 to which the uncoated region 12a of the anode 121 is welded, and the cathode terminal 142 may be electrically connected to the cathode current collecting plate 152 to which the uncoated region 12b of the cathode 122 is welded.

Referring to FIGS. 1 and 2, the anode terminal 141 and the cathode terminal 142 may be electrically connected to the current collecting plates 150 through connection pins 145 (145a and 145b). For example, through holes may be formed in the cap plate 130 and the electrode terminals 140, and the connection pins 145 may pass through the through holes. One side of each of the connection pins 145 may be welded to one of the current collecting plates 150, and the other side thereof may be welded to one of the electrode terminals 140.

However, the connection structure between the electrode terminal 140 and the electrode (e.g., the cathode 122 or the anode 121) described above is merely an example. That is, the electrode terminal 140 and the electrode may be electrically connected to each other and are not limited to the above-described connection structure.

The vent portion 170 may be a component for preventing explosion of the battery cell 100. For example, gas may occur in the cell case 110 due to repeated charging and discharging of the battery cell 100, and when internal pressure of the cell case 110 reaches a predetermined level due to gas occurring therein, the gas in the cell case 110 may be discharged outward through the vent portion 170.

The vent portion 170 may be provided in the cap plate 130. The vent portion 170 may include a notch portion 171 having a smaller thickness than other portions. Accordingly, when internal pressure of the cell case 110 reaches the predetermined level, the notch portion 171 may first be broken and gas in the cell case 110 may be discharged outward through the vent portion 170.

The injection hole 160 may be formed in the cap plate 130. During electrolyte injection, electrolyte may be injected into the battery cell 100 through the injection hole 160. After electrolyte is injected, the injection hole 160 may be sealed using a sealing ball 165.

The air hole 180 may provide a passage through which air in the cell case 110 is discharged during electrolyte injection into the cell case 110. When air in the cell case 110 is not discharged outward during electrolyte injection, an injection speed of electrolyte may gradually decrease due to air pressure in the cell case 110. The outside and inside of the cell case 110 may communicate with each other through the air hole 180, and air in the cell case 110 may be discharged outward through the air hole 180 during electrolyte injection. Accordingly, the air hole 180 may prevent a decrease in the electrolyte injection speed during electrolyte injection. In this case, the air hole 180 may be a component separate from the vent portion 170 and the injection hole 160.

The temperature determining unit 190 may be at least partially discolored according to the internal temperature of the cell case 110. Accordingly, an operator may intuitively check an internal temperature of the battery cell 100 by using the temperature determining unit 190.

The temperature determining unit 190 may be installed in the air hole 180. When the temperature determining unit 190 is installed in the vent portion 170, the temperature determining unit 190 may interfere with gas discharge from the cell case 110 in an abnormal state of the battery cell 100. However, when the temperature determining unit 190 is installed in the air hole 180, an internal state of the battery cell 100 may be intuitively recognized from the outside while not interfering with gas discharge from the vent portion 170 in the abnormal state of the battery cell 100.

According to an embodiment, at least a part of the temperature determining unit 190 may be disposed in the cell case 110. Accordingly, the internal temperature of the cell case 110 may be immediately reflected and recognized from the outside.

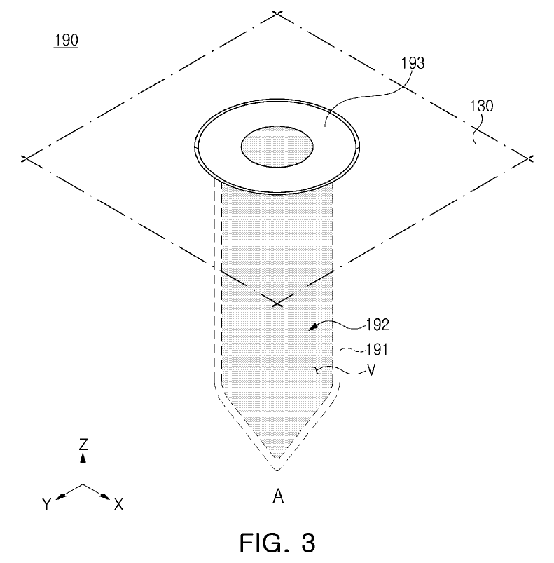

FIG. 3 is an enlarged perspective view of portion A of FIG. 1.

Referring to FIG. 3, according to an embodiment, the temperature determining unit 190 may include a body portion 191 coupled to the air hole 180 and including an accommodation space V therein, a discoloration material 192 accommodated in the accommodation space V and discolored as temperature changes, and a cover 193 covering an opening of the body portion 191.

The body portion 191 may include the accommodation space V therein. The body portion 191 may include the opening at one side. The body portion 191 may be coupled to the air hole 180 and may extend into the cell case 110. The body portion 191 may have a cylindrical shape. However, the shape of the body portion 191 is not limited thereto, and the body portion 191 may have any shape as long as the body portion 191 includes the accommodation space V therein and is capable of accommodating the discoloration material 192.

The discoloration material 192 may be accommodated in the accommodation space V of the body portion 191 through the opening of the body portion 191. The discoloration material 192 may be discolored as temperature changes. For example, the discoloration material 192 may include at least one thermochromic pigment discolored at a specific temperature.

The thermochromic pigment may refer to a material whose molecular structure changes at or above the specific temperature, thereby changing a light absorption property and causing a color change. The specific temperature at which the thermochromic pigment changes color may differ depending on the thermochromic pigment, and accordingly, an appropriate thermochromic pigment may be selected so that discoloration occurs at a desired temperature.

According to an embodiment, the discoloration material 192 may include a first thermochromic pigment discolored to a first color at a first temperature, and a second thermochromic pigment discolored to a second color at a second temperature higher than the first temperature. In this case, the first color and the second color may differ from each other.

Discoloration at a specific temperature may indicate discoloration at or above the specific temperature or discoloration at a temperature exceeding the specific temperature. Accordingly, the discoloration material 192 may be discolored to the first color by the first thermochromic pigment at the first temperature. When the temperature continuously increases and reaches the second temperature, the discoloration material 192 may then be discolored to the second color by the second thermochromic pigment. For example, a temperature equal to or higher than the first temperature and lower than the second temperature may indicate a temperature of the battery cell 100 during normal operation, and a temperature equal to or higher than the second temperature may indicate a temperature of the battery cell 100 during abnormal operation. Accordingly, the first color may indicate the normal operation and the second color may indicate the abnormal operation.

According to an embodiment, at least a part of the cover 193 may be formed of a transparent material to allow a color of the discoloration material 192 to be determined from the outside. Accordingly, an operator may intuitively check the internal state of the battery cell 100 from the outside of the battery cell 100. Accordingly, when a problem occurs in the battery device 10 including the plurality of battery cells 100, it is possible to immediately check which battery cell 100 has the problem.

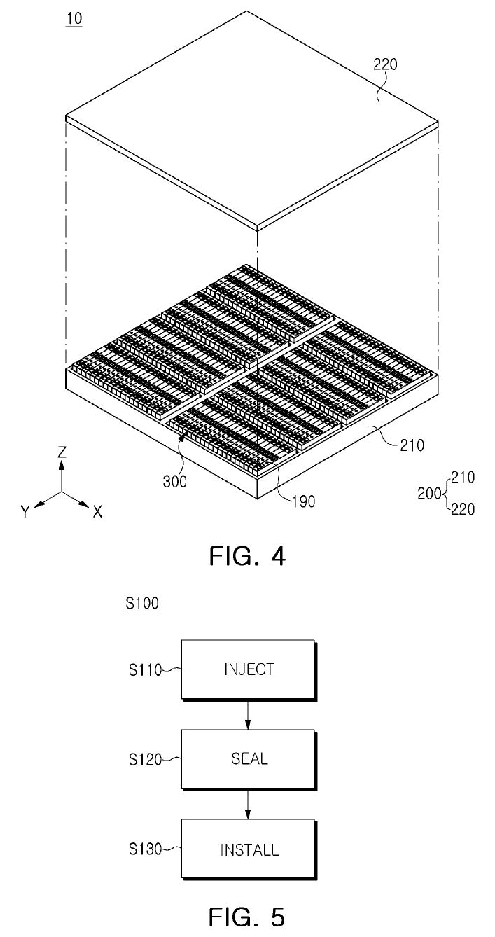

FIG. 4 is a perspective view of the battery device 10 according to an embodiment.

Description of the battery cell 100 illustrated in FIGS. 1 and 2 and the temperature determining unit 190 illustrated in FIG. 3 may also be applied to the battery cell 100 and the temperature determining unit 190 illustrated in FIG. 4.

Referring to FIG. 4, the battery device 10 according to the present disclosure may include a cell assembly 300 including the plurality of battery cells 100, and a housing 200 including a housing body 210 in which the cell assembly 300 is disposed and a housing cover 220 covering the cell assembly 300.

The cell assembly 300 may include the plurality of battery cells 100. The plurality of cell assemblies 300 may be disposed in the housing body 210. The housing cover 220 may cover the plurality of cell assemblies 300 disposed in the housing body 210. In this case, the cap plate 130 of the battery cell 100 and the housing cover 220 may face each other.

The battery device 10 may include the plurality of cell assemblies 300 and the housing 200. In this case, the battery device 10 may be a battery module or a battery pack. When the battery device 10 is a battery pack, the battery device 10 may have a cell-to-pack (CTP) structure.

According to an embodiment, the temperature determining unit 190 may include the body portion 191 coupled to the air hole 180 and including the accommodation space V therein, the discoloration material 192 accommodated in the accommodation space V and discolored as temperature changes, and the cover 193 covering the opening of the body portion 191.

According to an embodiment, at least a part of the cover 193 may be formed of a transparent material to allow a color of the discoloration material 192 to be determined from the outside. Accordingly, an operator may intuitively check the internal state of the battery cell 100.

In this case, according to an embodiment, at least a part of the temperature determining unit 190 may face the housing cover 220. For example, the cover 193 (see FIG. 3) may face the housing cover 220. Accordingly, when repairing the battery device 10, an operator may immediately check which battery cell 100 has a problem only by disassembling the housing cover 220 of the battery device 10.

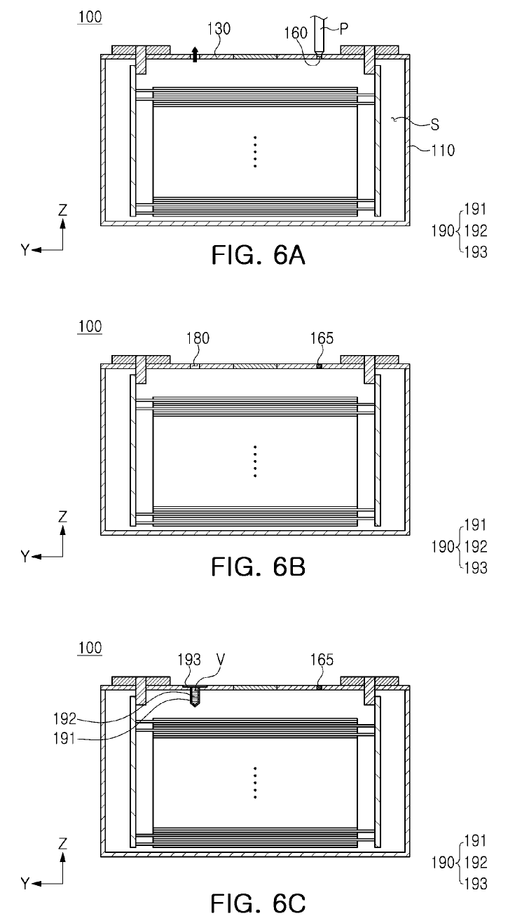

FIG. 5 is a flowchart of a battery cell manufacturing method S100 according to an embodiment. FIGS. 6A-6C are a cross-sectional view of the battery cell 100 during an electrolyte injection process.

The description of the battery cell 100 illustrated in FIGS. 1 and 2 may also be applied to the battery cell 100 illustrated in FIGS. 6A-6C.

Referring to FIGS. 5 -6C, the battery cell manufacturing method S100 according to the present disclosure may include: injecting electrolyte into the battery cell 100 through the injection hole 160 (S110); sealing the injection hole 160 (S120); and installing, in the battery cell 100, the temperature determining unit 190 capable of determining an internal temperature of the battery cell 100 (S130). The temperature determining unit 190 may be installed in the air hole 180 providing a passage through which internal air of the battery cell 100 is discharged during electrolyte injection into the battery cell 100.

The injecting (S110) may indicate injecting electrolyte into the internal space S of the cell case 110. An electrolyte injector may be coupled to the injection hole 160 of the cap plate 130 to inject electrolyte. Electrolyte may flow into the internal space S of the cell case 110 through the injection hole 160.

According to an embodiment, the injecting (S110) may include discharging air in the internal space S outward from the cell case 110 through the air hole 180 during electrolyte injection.

That is, air occupying the internal space S may be discharged outward from the cell case 110 through the air hole 180 as electrolyte is injected thereinto. Accordingly, an increase in pressure in the internal space S of the cell case 110 may be prevented as electrolyte is injected thereinto, thereby preventing the electrolyte injection speed from gradually decreasing.

The sealing (S120) may indicate sealing the injection hole 160 after completion of electrolyte injection through the injection hole 160. Sealing of the injection hole 160 may be performed by inserting the sealing ball 165. Alternatively, sealing may be performed by inserting the sealing ball 165, covering the sealing ball 165 with an injection hole cover (not shown), and welding the injection hole cover. The sealing (S120) may be performed after the injecting (S110).

The installing (S130) may indicate installing, in the battery cell 100, the temperature determining unit 190 capable of determining the internal temperature of the battery cell 100. The temperature determining unit 190 may be installed in the air hole 180 of the battery cell 100. The air hole 180 may provide a passage through which air in the internal space S of the cell case 110 is discharged outward from the cell case 110 during electrolyte injection into the battery cell 100.

At least a part of the temperature determining unit 190 may face the internal space S of the cell case 110. For example, the body portion 191 of the temperature determining unit 190 may face the internal space S of the cell case 110. The body portion 191 may be disposed in the air hole 180 and then welded. The cover 193 may then cover the opening of the body portion 191.

Alternatively, after the cover 193 covers the opening of the body portion 191, the body portion 191 may be installed in the air hole 180. The discoloration material 192 may be accommodated in the accommodation space V of the body portion 191 before the cover 193 covers the opening of the body portion 191.

The installing (S130) may be performed after the injecting (S110). Accordingly, during electrolyte injection, air in the internal space S may be discharged outward from the cell case 110 through the air hole 180.

An embodiment of the present disclosure may provide the battery cell, the battery device including the same, and the battery cell manufacturing method in which the electrolyte injection speed is improved, thereby improving processability.

An embodiment of the present disclosure may provide the battery cell, the battery device including the same, and the battery cell manufacturing method in which the internal state of the battery cell is capable of being intuitively determined.

Only specific examples of implementations of certain embodiments are described. Variations, improvements and enhancements of the disclosed embodiments and other embodiments may be made based on the disclosure of this patent document.

What is claimed is:

1. A battery cell comprising:
a cell case having an internal space and including an opening in at least one side thereof;
an electrode assembly disposed in the internal space;
a cap plate covering the opening of the cell case;
a vent portion opened as the internal space reaches a pressure within a predetermined pressure range;
an air hole formed in the cap plate and providing a passage through which internal air of the cell case is discharged during electrolyte injection;
an injection hole formed in the cap plate and providing a passage through which electrolyte is injected; and
a temperature determining unit at least partially discolored according to an internal temperature of the cell case,
wherein the temperature determining unit is installed in the air hole.

2. The battery cell of claim 1, wherein the temperature determining unit includes
a body portion coupled to the air hole and including an accommodation space therein, a discoloration material accommodated in the accommodation space and discolored as temperature changes, and a cover covering an opening of the body portion.

3. The battery cell of claim 2, wherein at least a part of the cover is formed of a transparent material to allow a color of the discoloration material to be determined from the outside.

4. The battery cell of claim 2, wherein the discoloration material includes at least one thermochromic pigment discolored at a specific temperature.

5. The battery cell of claim 2, wherein the discoloration material includes
a first thermochromic pigment discolored to a first color at a first temperature, and
a second thermochromic pigment discolored to a second color at a second temperature higher than the first temperature, and
the first color and the second color differ from each other.

6. The battery cell of claim 1, wherein at least a part of the temperature determining unit is disposed in the cell case.

7. A battery device comprising:
a cell assembly including a plurality of battery cells; and
a housing including a housing body in which the cell assembly is disposed and a housing cover covering the cell assembly,
wherein the battery cell includes
a cell case having an internal space and including an opening in at least one side thereof;
an electrode assembly disposed in the internal space;
a cap plate covering the opening of the cell case;
a vent portion opened as the internal space reaches a pressure within a predetermined pressure range;
an air hole formed in the cap plate and providing a passage through which internal air of the cell case is discharged during electrolyte injection;
an injection hole formed in the cap plate and providing a passage through which electrolyte is injected; and
a temperature determining unit discolored according to an internal temperature of the cell case,
the temperature determining unit being installed in the air hole.

8. The battery device of claim 7, wherein the temperature determining unit includes
a body portion coupled to the air hole and including an accommodation space therein, a discoloration material accommodated in the accommodation space and discolored as temperature changes, and a cover covering an opening of the body portion.

9. The battery device of claim 8, wherein at least a part of the cover is formed of a transparent material to allow a color of the discoloration material to be determined from the outside.

10. The battery device of claim 7, wherein at least a part of the temperature determining unit faces the housing cover.

11. The battery device of claim 8, wherein the cover faces the housing cover.

12. A battery cell manufacturing method comprising:
injecting electrolyte into a battery cell through an injection hole;
sealing the injection hole; and
installing, in the battery cell, a temperature determining unit capable of determining an internal temperature of the battery cell,
wherein the temperature determining unit is installed in an air hole providing a passage through which internal air of the battery cell is discharged during electrolyte injection into the battery cell.

13. The manufacturing method of claim 12, wherein the injecting includes discharging air in an internal space outward from a cell case through the air hole during electrolyte injection.

14. The manufacturing method of claim 12, wherein the installing is performed after the injecting.
